(19) United States
(12) Patent Application Publication
(10) Pub. No.: US 2026/0006033 A1
(43) Pub. Date: Jan. 1, 2026

(54) SYSTEMS AND METHODS FOR SMART VERIFICATION

(71) Applicant: STRIPE, INC., South San Francisco, CA (US)

(72) Inventors: Michiaki Kono, Brooklyn, NY (US); Alden Seabolt, Burlingame, CA (US); Andrew Wang, San Francisco, CA (US)

(21) Appl. No.: 18/758,325

(22) Filed: Jun. 28, 2024

(51) Int. Cl. H04L 9/40

(52) U.S. Cl. CPC H04L 63/102; H04L 63/1425

(57) ABSTRACT

Systems and methods for silent verification of entities accessing a service are disclosed. One method may include receiving a first input identifying an entity engaged in a flow for accessing a service and utilizing the information to evaluate a risk score of the entity using a machine learning (ML) model. The machine learning model takes as input associations of the entity that are based on an access history of the entity for a second service that is stored in the server, and a type of access to the service. The method then determines a second input using the risk score of the entity as an input to an ML model. The second input is later transmitted to the service to update the flow to access the service.

### BACKGROUND

Individual services are limited in their view of an entity's online behavior and can fall prey to fraudsters who have committed fraud to access other similar services. Additionally, imposters utilize the good online behavior of other entities to defraud services.

The above information disclosed in this Background section is only for enhancement of understanding of the present disclosure, and therefore, it may contain information that does not form the prior art that is already known to a person of ordinary skill in the art.

### SUMMARY

In one or more embodiments, the present disclosure is directed to systems and methods for providing smart and silent verification of entities accessing a service, substantially as shown in and/or described in connection with at least one of the figures, as set forth more completely in the claims. The scope of the invention is defined by the appended claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 depicts a computing environment of a silent verification system for the verification of entities according to one or more embodiments;

1 FIG. 2A depicts a data flow diagram of the silent verification system according to one or more embodiments;

FIG. 2B depicts a UI flow diagram of the silent verification system according to one or more embodiments;

FIG. 2C depicts a UI flow diagram of the silent verification system according to one or more embodiments;

FIG. 2D depicts a UI flow diagram of the silent verification system according to one or more embodiments;

FIG. 2E depicts a UI flow diagram of the silent verification system to help utilize the previously stored information to verify an entity according to one or more embodiments;

FIGS. 3A-B depicts a handshake sequence diagram for silent verification to access a service according to one or more embodiments;

FIG. 4 depicts a flow diagram of a process for silent verification of an entity at each stage in a flow to access a service according to one or more embodiments;

FIG. 5 depicts a flow diagram of a process for determination of the next stage in a flow to access a service according to one or more embodiments;

FIG. 6 depicts a flow diagram of a process for dynamic selection of the next stage in a flow to access a service according to one or more embodiments;

FIG. 7 is a block diagram illustrating a high-level network architecture of a computing system environment for operating a silent verification system according to embodiments of the present disclosure;

FIG. 8 is a block diagram illustrating a representative software architecture, which may be used in conjunction with various hardware architectures as described herein; and

FIG. 9 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

A merchant may offer services using a financial services platform provided by a financial service provider. The financial services platform offers financial services including, processing payments (e.g., credit card processing, bank transfers, financing loans), handling disputes (e.g., payment disputes, warranty issues), and storing sensitive information (e.g., credit card information, shopping and billing addresses, and social security numbers). Multiple merchants may use the financial services platform to provide services to an entity (e.g., a customer, which may be an individual consumer or a business), giving the financial service provider a broader insight into an entity based on the entity's interaction with the services offered by the merchants.

There may be risks in providing services to the entities by merchants offering services, especially with a limited understanding of the entity. Some risks are associated with a likelihood that the entity will breach the terms of service (ToS) agreement specifying how an entity is allowed to use the services the merchant provides, for example, obtaining a referral bonus for services offered by merchants by referring and creating fake entities. Other risks relate to whether the entity may be attempting to defraud the merchant, such as by providing falsified information. Breaches of different terms within the agreement may be associated with different levels or types of risk (e.g., breaching a term of service requiring the entity to be limited to one free trial on an account to illegally gaining multiple free bonuses by making referrals to fake customers to return fraud such as returning a package for a refund after removing the valuable item within the package). Some other risks may include the risk that the entity's account may be taken over by a third-party, which may result in fraudulent transactions while the account is controlled by the third-party, such as a using a credit card assigned to a different entity.

These various risks can be evaluated by obtaining additional information about the entity and services and mitigated through various interventions prior to accessing the services offered by merchants. For example, the risk associated with account takeover can be reduced by implementing multi-factor authentication, reducing the scope of rights available to authentication keys (e.g., for accessing application programming interfaces or APIs exposed by the financial services platform), and the like. As another example, the risk of fraud can be reduced by verifying the identity of the entity (e.g., through a government-issued identification card and verification of the corresponding person), and/or by verifying documents of incorporation associated with a corporate entity.

Interventions such as obtaining additional information about an entity and performing mitigating actions can reduce the risk to the merchant's business by reducing the risks associated with the entity and/or by improving the accuracy of assessments of the riskiness of specific entities (e.g., the probability that providing services to the entities will result in harm to the business). However, these interventions cost those entities and may result in a degraded experience. This may harm relationships with entities acting in good faith (e.g., not attempting to defraud the merchant). For example, requesting an entity to use a multi-factor authentication can result in user frustration in managing multi-factor authentication, and may sometimes result in account lockouts and increased customer support interactions. As another example, requesting customers to undergo an identity verification process may require individuals to provide sensitive personal information (e.g., photographs of government identification, personal identification numbers such as social security numbers, credit checks, and the like).

As such, aspects of embodiments of the present disclosure relate to generating a risk score for an entity during an interaction and selecting interventions for gathering information about the entity for estimating different types of risks that the entity may pose to a merchant providing services to the entity. The computed risks may be used to evaluate or reevaluate the entity's risk score. The financial services platform may use the computed risk score to determine whether to recommend a merchant to continue to allow the entity access to a service provided by the merchant, whether to perform an intervention, and/or to determine the risk posture to be taken for the entity.

In some embodiments, the selected interventions optimize the gathering of relevant information regarding the entity to improve the accuracy of the estimated risks in exchange for a relatively low or minimized cost to the entity (e.g., minimizing the entity's pain or degraded experience). In some embodiments, the type of intervention to perform, and the timing of the intervention, are computed based on one or more machine learning (ML) models trained on historical data relating the effectiveness of various interventions on entities that have similar characteristics and may be at various stages of accessing services or in relationship with the merchant. The ML models also consider the cost to the entities to respond to these interventions.

As such, aspects of embodiments of the present disclosure provide automated techniques to generate a risk score of an entity for consolidating a risk posture towards the entity and to select and schedule interventions for entities who are classified as being untrustworthy to attempt to improve the trustworthiness of that entity and/or to drive fraudulent entities from accessing the service provided by a merchant.

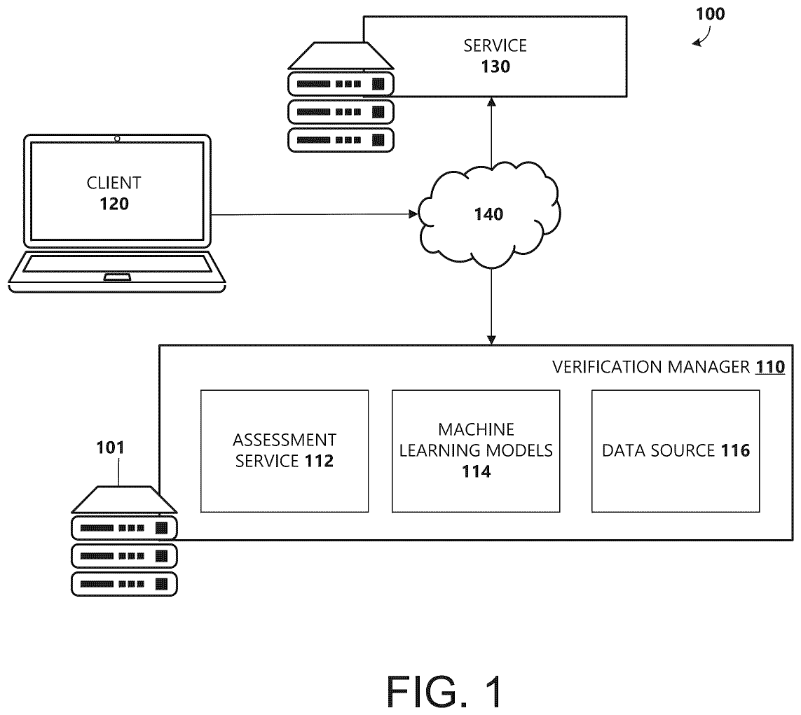

FIG. 1 depicts a block diagram of silent verification system 100's computing environment for silent verification of entities according to one or more embodiments. Silent verification system 100 includes verification manager 110, client 120, and service 130 coupled to one another over a data communication network 140. Verification manager 110 verifies entities associated with client 120 and accessing service 130. Verification manager 110 shares risk scores and provides intervention recommendations for service 130 to determine the path to accessing service 130.

In some embodiments, verification manager 110 is a computing device, such as computing device 101 or runs on a computing device 101. Verification manager 110 verifies entities such as client 120 and entities using client 120 to access service 130. Verifying entities includes authentication and authorization of the entity to access service 130. In some examples, the verification determines whether the entity is authorized to access service 130. Verification manager 110 verifies client 120 by using information about client 120 stored previously. Information about client 120 includes access to service 130 and other services. In some examples, verification manager 110 verifies client 120's ability to access a feature provided by service 130. For example, verification manager 110 verifies that client 120 is accessing a trial for a pro feature offered by service 130. In some examples, the verification may include information provided by service 130 to verification manager 110. Authorization may include confirming the authenticity of the entity.

In some embodiments, verification manager 110 includes a processor and a memory, where the memory includes instructions that cause the processor to provide different types of transaction processing functionality. The verification functionality may include, for example, analyzing client 120's interactions for potential fraud, interacting with service 130 for approving or declining interaction to access service 130, and interacting with client 120 to configure an interaction path for an entity to access service 130. An interaction path includes one or more user interfaces (UIs) presented on client 120 to approve access to service 130. For example, an interaction path can be a signup wizard of UI screens for a trial of service 130.

In some embodiments, verification manager 110 is configured to evaluate an entity associated with client 120 and classify the entity according to a risk score. The risk score may be a composite indicia of the trustworthiness of the entity. For example, the risk score may take the form of a value for classifying the entity as trusted, untrusted, or unknown. In some examples, the risk score may have a range of values, resulting in different recommendations to amend an entity's path of access to a service 130. The amended path includes additional verification steps, verification steps to skip certain stages of a path to access service 130, and/or rejection of access to service 130. In some embodiments, the risk score is computed based on an evaluation of an entity in one or more risk areas. The evaluation may be based on one or more risk models (e.g., machine learning models) that have been trained to predict different types of risks. In some embodiments, outputs of the risk models are used to determine the risk score.

In some embodiments, interventions are selected post-assessing or reassessing various types of risk and/or for computing or recomputing the risk score of an entity. The interventions may be selected to increase or maximize the accuracy of a prediction of risk associated with an entity while reducing or minimizing the cost associated with the action. In this regard, the predictive power of the interventions may be evaluated based on the entity and context surrounding the entity to determine which intervention(s) may be appropriate for the current situation. For example, if an entity is deemed to be “untrusted” because of the risk of violating the terms of service, an intervention that requests for the entity to provide identity verification may not be useful in getting a better assessment of the risk. However, identity verification may be useful for determining the risk of an account takeover by the merchant.

Responding to an intervention may incur a cost to the entity in terms of disruption, inconvenience, or effort (collectively referenced as “pain”). In some embodiments, the selected interventions are scheduled or timed to minimize the pain to the entity. This may involve, for example, issuing the intervention proactively (e.g., signup path to access service 130) instead of after the entity has been accessing service 130 for a period of time, which may cause more disruption to the entity.

In some embodiments, the risk score assigned to an entity is used by verification manager 110 to determine a recommendation with respect to the entity. In some embodiments, the type of response by the transaction server 104 to a risk situation involving the merchant may differ based on the merchant's trust metric. For example, if an activity by an entity that is classified as “untrustworthy” is identified as being potentially fraudulent, verification manager 110 may invoke an intervention and/or the like. If, however, the entity is classified as “trustworthy,” verification manager 110 may invoke additional review to confirm that the activity is indeed fraudulent before invoking an intervention or taking action to counter the fraud, because intervening in a legitimate or bona fide activity may result in a degraded user experience for the entity. Thus, classifying entities that should be classified as such as early as possible may increase the chance that trusted (e.g., high value) entities do not experience bad or degraded user experience. On the other hand, interventions or other actions for risk violations for “untrusted” entities may be warranted. Thus, fewer resources may be devoted to confirming the risk violations by “untrusted” entities.

As illustrated in FIG. 1, verification manager 110 includes assessment service 112, machine learning (ML) models 114, and data source 116 to verify client 120 by assessing the risk involved in allowing interaction by client 120 to access service 130. Assessment service 112 assesses an action by client 120 when accessing service 130 to recommend the following action. Action may include an action to access a feature of service 130. For example, a user of client 120 signups for a trial period of a subscription offered by service 130.

Machine learning models 114 include multiple machine learning models trained using data about an entity, such as client 120 and user of client 120, when accessing various services, such as service 130. The training data may include data of entities and services 130 that are part of silent verification system 100. In some examples, ML models 114 training data includes information about the same entity on other systems.

Verification manager 110 can detect activity from the same entity (e.g., fraudster) across multiple merchant services (e.g., service 130) that use the verification manager 110. This allows verification manager 110 access to transaction information across services, including determinations that some of these transactions constituted fraud, as determined after the fact. ML models 114 use the determinations of the transactions as training labels for those transactions. ML models 114 are trained with transaction data with labels that indicate fraud and are not available to a single merchant.

Data source 116 includes data used to train ML models 114 and help verify client 120 and entities using client 120. Data source 116 provides data to assess the risk of authorizing client 120 from accessing service 130 to perform a specific action. Data source 116 may include databases that are part of silent verification system 100 and other databases accessed via an API by verification manager 110. In some examples, data source 116 are databases accessed by verification manager 110 over data communication network 140.

Data source 116 includes interaction information for various entities across multiple merchant services. For example, interaction information may include transaction information of the entities. In some examples, data source 116 includes transaction information using verification manager 110, which verifies and stores successful and fraudulent transactions. The labels for successful and fraudulent transactions may be obtained post-transaction based on information provided by a service (e.g., service 130). In some examples, data source 116 includes transactions categorized as successful and fraudulent by other managers (e.g., payment gateways). The transactions managed by other managers may be included in data source 116 using an API.

Client 120 may be a desktop, laptop, mobile device, smartphone, tablet, and/or any other computing device conventional in the art. A customer, potential customer, fraudster, or other end user which may be associated with a browser, an IP address, cookie, or other computer-detectable identifier may collectively be referenced as an entity desiring to purchase goods or services from a merchant may access service 130 using client 120. Client 120 may include a client application used for accessing service 130. For example, client 120 provides a web browser as a client application for an entity to point to a URL for accessing service 130. In some examples, service 130 may directly communicate with verification manager 110 to verify and validate the interaction of an entity to access service 130.

Client 120 may also be configured to receive interruptions, interventions, and/or other actions (collectively referenced as interventions) from verification manager 110 during or after an entity interacts to access service 130 that a merchant provides. For example, verification manager 110 generates an intervention to assess (or reassess) the risk score of an entity. The intervention may include a request for information from the entity. The entity may respond to the request using client 120.

In some embodiments, client 120 communicates with verification manager 110 to process payment for the products purchased by the end user (either online via the web page or application or via the POS terminal). Service 130 may collect the transaction information, such as, for example, entity information (e.g., name, shipping address, billing address, and the like), credit card information, purchase amount, and/or the like, and transmit the transaction information to verification manager 110.

In some embodiments, client 120 includes a point-of-sale (POS) terminal at a service provider's location. The POS terminal may include a processor and memory. The memory may store instructions that cause the process to provide checkout functionality for products purchased by an end user from the merchant location. For example, the POS terminal may include software and hardware for accepting credit card information, forwarding the credit card information and associated purchase details to verification manager 110 for approval, and displaying an indication as to whether the credit card has been approved or declined for the requested purchase amount.

In some embodiments, client 120 includes a computing device for communicating with verification manager 110 over data communications network 140. The computing device may be a desktop, laptop, mobile device, smartphone, tablet, and/or any other computing device conventional in the art. An entity may access verification manager 110 using client 120, for example, when signing up for a service offered by service 130. Information may be exchanged between client 120 and verification manager 110 during the signup process.

Service 130 may include one or more servers and/or computing devices. The servers and/or computing devices may include a processor and memory. The memory may include instructions that, when executed by the processor, cause the processor to provide merchant functionality as described herein. For example, service 130 may provide a web page or application that enables an entity to purchase goods and/or services (collectively referenced as products) sold by a merchant.

The data communications network 140 may be any wired or wireless local area network (LAN), private wide area network (WAN), and/or the public Internet. Verification manager 110 and service 130 may be hosted in a single server or distributed over multiple servers under the control of a single or multiple organizations.

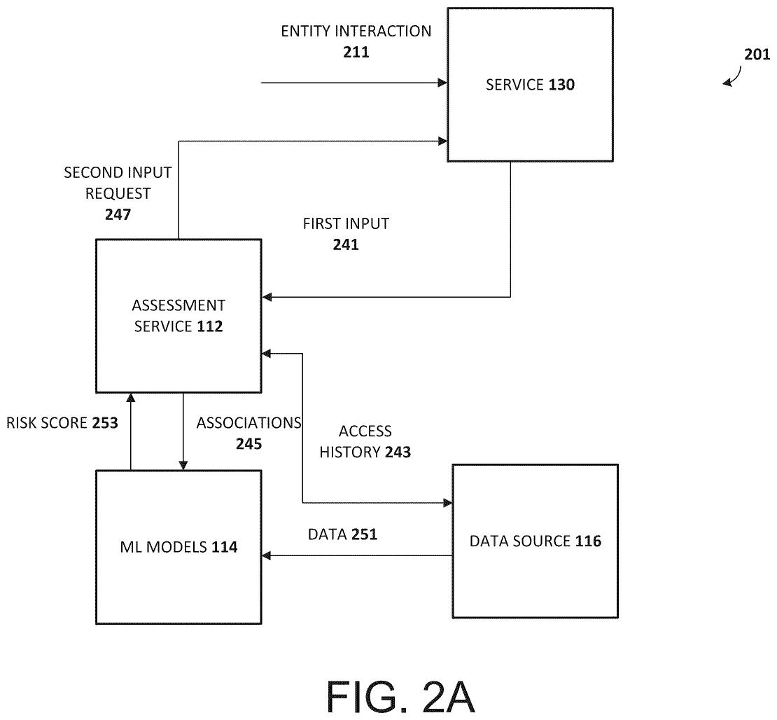

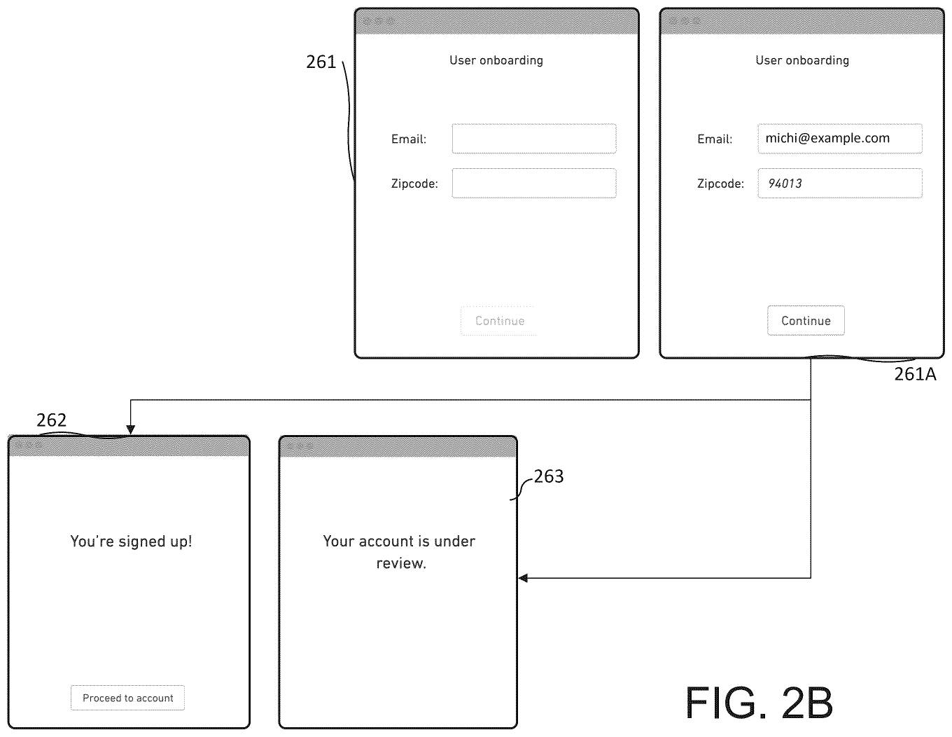

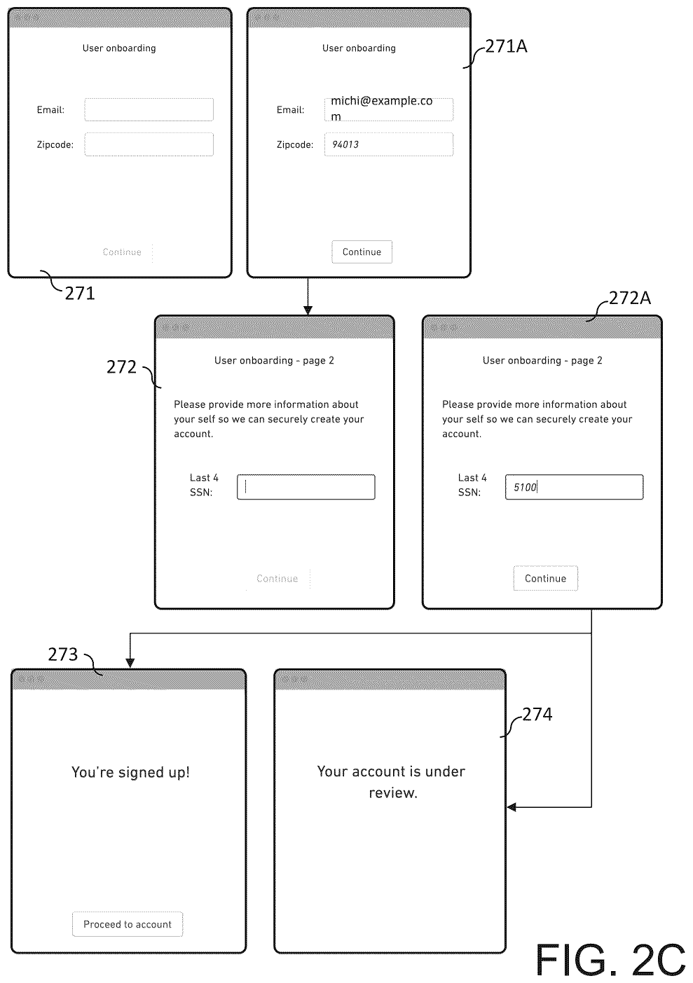

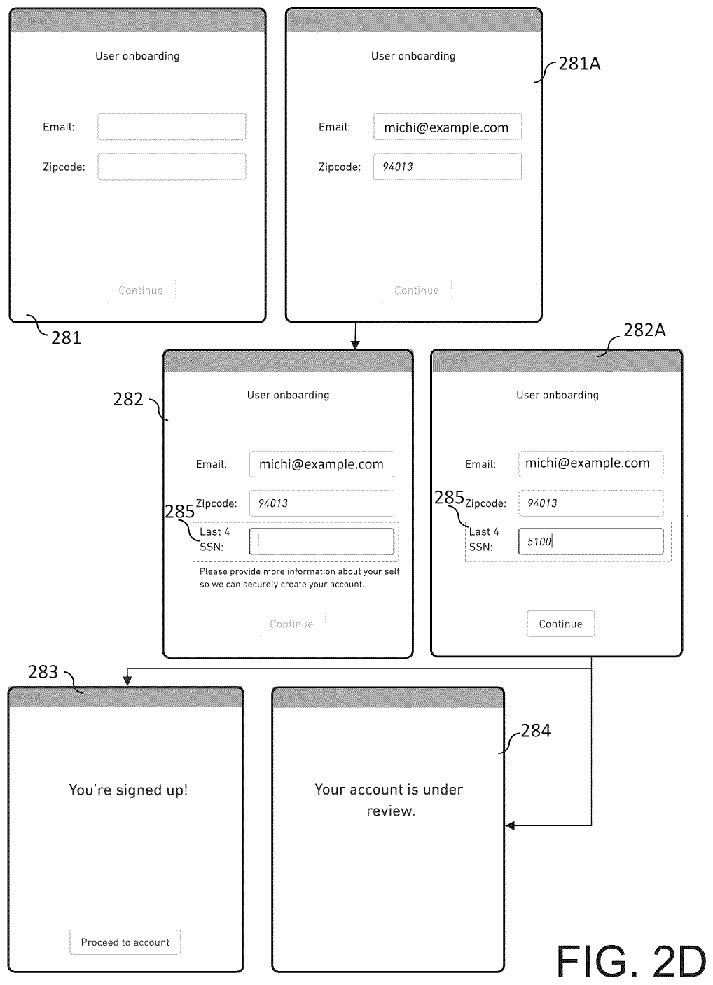

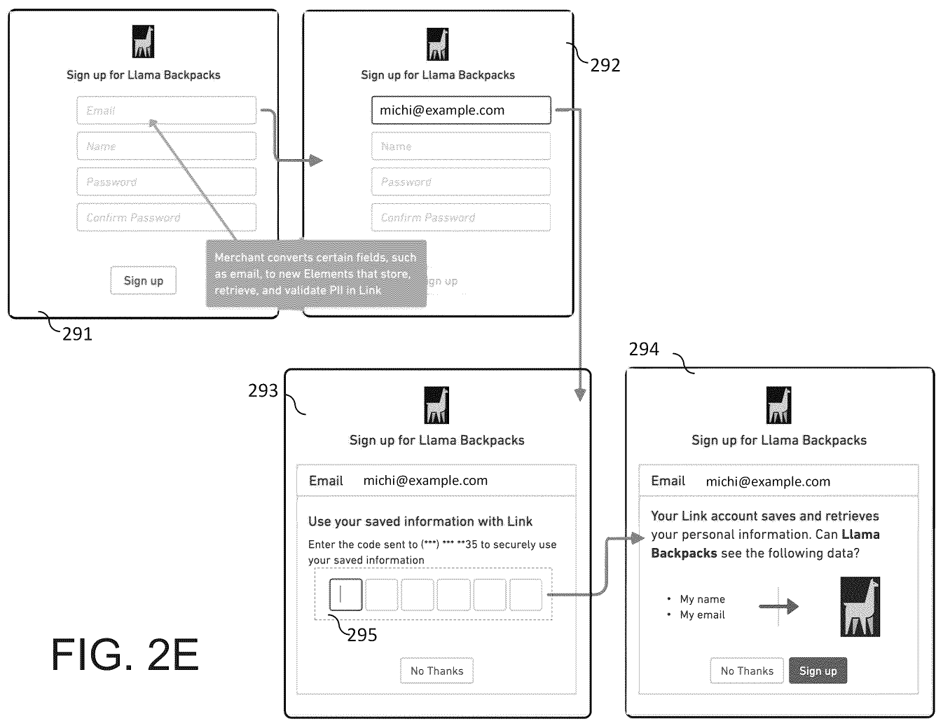

FIG. 2A depicts a data flow diagram of silent verification system 100 according to one or more embodiments. Service 130 helps trigger a verification based on an action by an entity (not shown in the figure). Service 130, upon receiving an interaction from an entity, processes it and requests verification of the entity for the interaction performed by the entity to access service 130. Based on the implementation details, service 130 may be split into multiple portions to connect with client 120 and verification manager 110. For example, service 130 may include a server and client component to interact with verification manager 110 and client 120, respectively.

In some examples, service 130 receives entity interaction 211 from an entity based on an action performed on client 120. Client 120 transmits entity interaction 211 to service 130 over a network (e.g., data communications network 140 of FIG. 1). In some examples, service 130 captures the entity interaction 211 for an action performed by an entity on client 120. In some examples, verification manager 110 may capture the entity interaction 211. For example, verification manager 110 may include a specialized user interface component included by service 130 in the user interface presented on client 120 to interact with service 130.

Service 130 processes entity interaction 211 and transmits first input 241 to assessment service 112 of verification manager 110. First input 241 includes information an entity provides as part of entity interaction 211. First input 241 also includes additional details of the entity's environment, such as information about client 120. Additional details of the environment of an entity may include location, IP address, a User Agent (UA) string identifying a browser of client 120 used to access service 130, the type of operating system running on client 120, or other software and hardware details of client 120.

Assessment service 112 receives the first input 241 and determines the risk of allowing an entity to access service 130. Assessment service 112 determines the risk associated with an entity as a risk score. Assessment service 112 determines a risk score and translates the risk score into a recommendation action for service 130 to present to an entity. The recommendation action may include additional interaction to perform to access service 130. The additional interaction is used to verify the entity or help skip some stages in the interaction path to access service 130. Assessment service 112 retrieves access history 243 from data source 116 to determine the risk of the current entity interaction 211 by an entity to access service 130. Access history 243 includes interactions of entity to service 130 and other services. In some examples, access history 243 includes interactions involving services not connected to verification manager 110. For example, interactions using a different payment gateway not providing silent verification and/or not using verification manager 110 to silently verify an entity's interaction to access a service (e.g., service 130 of FIG. 1). Access history 243 may be retrieved from a database, flat files, or other data formats stored in data source 116. Assessment service 112 updates data source 116 with access history 243, including information about entity interaction 211.

Assessment service 112 reviews access history 243 to determine the associations 245 relevant for an entity interaction 211 to access service 130. Associations 245 may include interactions of the entity accessing service 130. In some examples, associations 245 include interactions with entities similar to interaction 211 and/or interactions with services similar to service 130. Assessment service 112 may use ML models 114 to determine the interactions most relevant to entity interaction 211. Assessment service 112 transmits the determined associations 245 to ML models 114 to determine the risk of allowing an entity to access service 130.

ML models 114 take as input, data 251 from data source 116 and associations 245 to determine risk score 253 for entity interaction 211 performed by an entity to access service 130. Risk score 253 indicates the amount or level of risk with the entity interaction 211. The level of risks may be mapped to set levels such as “trusted,” untrusted,” or “fraudulent.” Each of the risk levels may include a range of risk scores. Risk score 253 is used to determine a recommendation as to the next stage of an interaction path to access service 130. The next stage may be an intermediary UI screen for additional information about the entity interacting to access service 130. An example of the UI flow of an intermediary UI screen for additional information is presented in FIG. 2C description below. In some examples, risk score 253 indicates the risk involved in allowing the entity performing entity interaction 211 using client 120 to continue performing interactions to access service 130. ML models 114 on evaluating a risk score 253 transmit the score to assessment service 112 to take action for the received interaction 211. ML models 114 may use associations 245 and data 251 as input prompts to generate risk score 253. In some examples, data 251 and other data in data source 116 may be used to train ML models 114 to determine risk score to associate with entity interaction 211. In some examples, ML models 114 include models to determine the most relevant associations 245 using access history 243 as an input prompt. In such scenarios, assessment service 112 directs data source 116 to provide the access history to ML models 114.

Assessment service 112 transmits a second input request 247 to service 130 as a recommendation to handle interaction 211 from an entity attempting to access service 130. Assessment service 112 determines second input request 247 based on risk score 253 of entity interaction 211. Second input request 247 may alter the path to access service 130 initially presented to an entity. The updated path may result in rejection of access to service 130 or allowing to continue interaction but with an additional input requirement as presented in second input request 247.

Second input request 247 as an additional input requirement is a recommendation to collect a second input from the entity to verify the entity further and reduce the risk of fraud. Second input is a field for entity interaction to provide additional information to confirm identity of an entity. The field may take as input an alphanumeric identifier, such as an email ID. In some examples, second input request 247 includes a request for identity verification, such as uploading an image of government-issued photo identification. An example of the UI flow of the second input for further verification is presented in FIGS. 2C and 2D descriptions below. In some examples, second input request 247 includes a request for information that allows for retrieval of previously stored information about an entity. For example, second input request 247 includes a request for an email ID to send a link to sign in and retrieve previously stored information about an entity. The previously stored information can help skip some stages in the interaction path to access service 130. An example of the UI flow of second input skipping certain stages is presented in FIG. 2E description below.

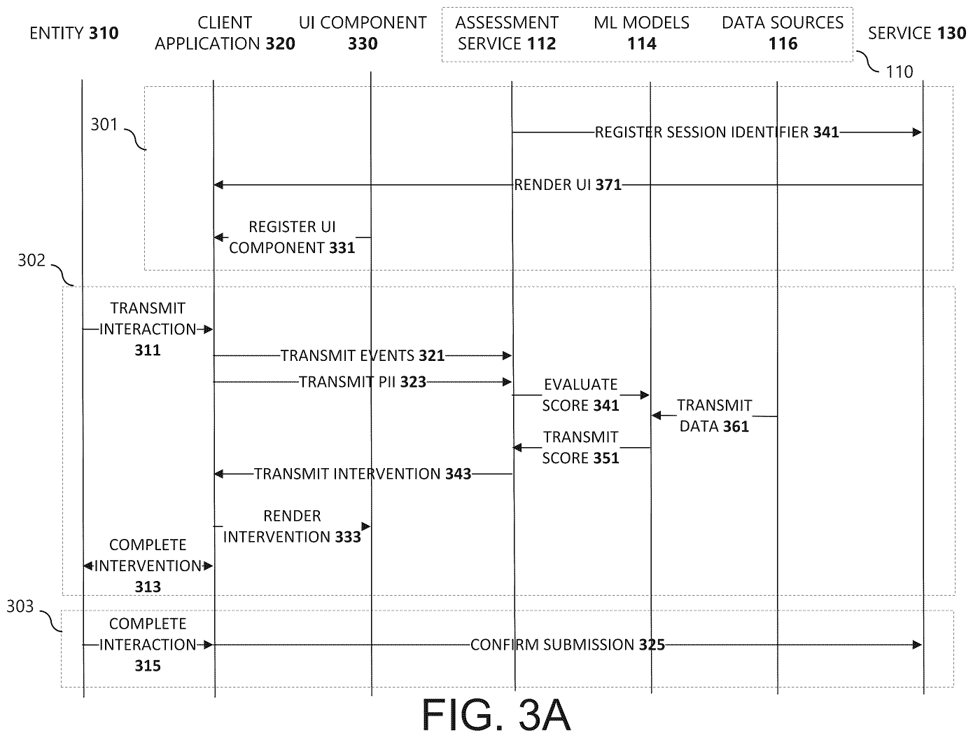

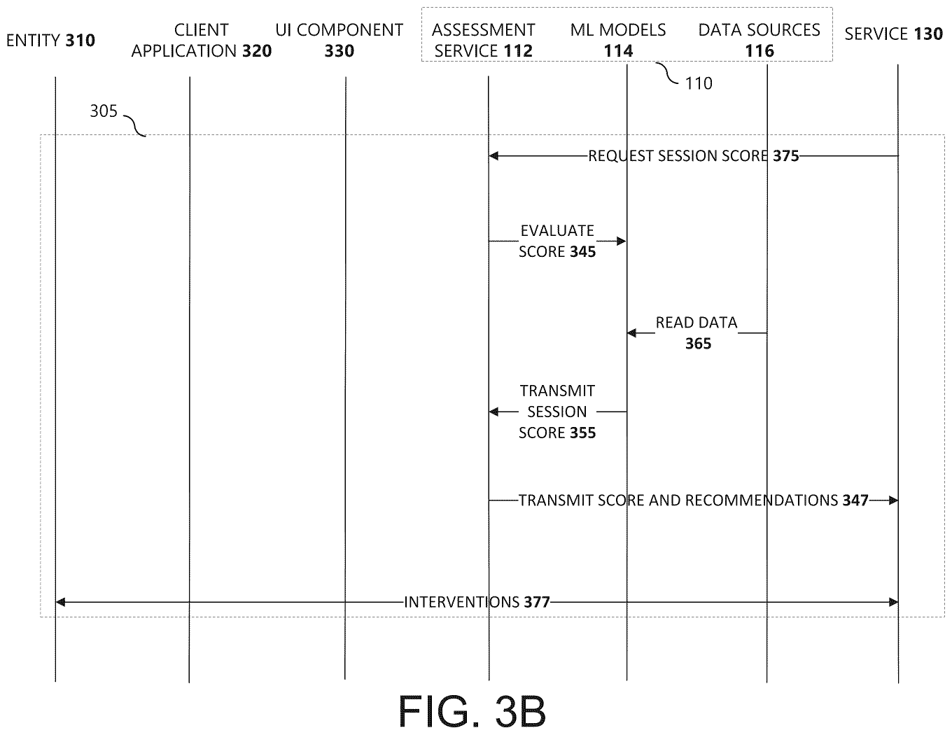

In some examples, second input request 247 may be a denial of an entity from accessing service 130. Service 130, upon receiving second input request 247, may accept or amend second input request 247. For example, service 130 updates the path to accessing service 130 based on the recommendation included in second input request 247. Alternatively, service 130 may ignore the recommendation to mitigate risk and continue with the previously determined interaction path for an entity to access service 130. Service 130 may update a user interface presented for entity interaction based on second input request 247. A detailed description of modifying a user interface for entity interaction to verify further the entity is presented in FIGS. 3A-B description below.

FIG. 2B depicts a UI flow diagram of the silent verification system 100 according to one or more embodiments. Silent verification system 110 automatically analyzes the inputs provided by an entity interacting with UI screen 261 to verify the entity. An entity is verified to determine the risk involved in allowing the entity to access a service. As illustrated in FIG. 2B, UI screen 261 presents fields for an entity to provide information to sign up for an account to access a service. When an entity interacts by providing information, as shown in UI screen 261A, silent verification system 100 performs a risk evaluation of the entity using a machine learning model (e.g., ML models 114) without any explicit request from the service. Based on the evaluated risk score, verification manager 110 (as shown in FIG. 1) of silent verification system 100 may allow access to the service by completing the account sign-up process. Alternatively, the service may use the risk score to block the entity from accessing the service as shown in UI screen 274, and temporarily or permanently restrict an entity from accessing the service.

FIG. 2C depicts another UI flow diagram of the silent verification system 100 according to one or more embodiments. In particular, the UI flow diagram depicts a second input request (e.g., second input request 247 of FIG. 2A) requiring additional verification to confirm the identity of the entity, for example, silent verification system 100 may require the entity to provide the last four digits of their social security number (SSN) as requested in UI screen 272. As illustrated in FIG. 2C, when an entity interacts (e.g., entity interaction 211 of FIG. 2A) with UI screen 271, to sign up for an account, associated with a service (e.g., service 130 of FIG. 1) by providing values to fields and clicking on “Continue” button, verification manager 110 (as shown in FIG. 1) may generate an intervention to modify the path to access service by requesting additional verification in UI screen 272. When an entity interacts with the intervention, verification manager 110 may perform another silent verification on inputs, as shown in UI screen 272A, to determine a risk using a machine learning model (e.g., ML models 114) to allow an entity to access a service. Based on the risk score, silent verification system 100 may allow access to the service by completing the sign-up process to create an account for accessing a service as shown in UI screen 273. Alternatively, based on the risk score, silent verification system 100 may perform a second intervention, as shown in UI screen 274, and temporarily restrict an entity from accessing the service. In other words, silent verification system 100 may select between allowing access to the service as shown in UI screen 273 and performing a second intervention as shown in UI screen 274, although embodiments of the present disclosure are not limited thereto and may include circumstances where no explicit indication of error or success is shown to the entity.

FIG. 2D depicts a UI flow diagram of the silent verification system 100 according to one or more embodiments. In particular, the UI flow diagram depicts a second input request (e.g., second input request 247 of FIG. 2A) requiring additional verification to provide the last four digits of the social security number as requested in UI screen 282. When an entity interacts (e.g., entity interaction 211 of FIG. 2A) with UI screen 281 associated with a service (e.g., service 130 of FIG. 1) by providing input values for fields and clicking on the “Continue” button, verification manager 110 (as shown in FIG. 1) of silent verification system 100 may generate an intervention to modify the path to access service by requesting additional verification. The additional verification is presented by modifying UI screen 281 by adding field 285 to generate UI screen 282. Similar to the UI flow presented in FIG. 2C description above, the silent verification system 100 may perform another silent verification on inputs provided in UI screen 282, as shown in UI screen 282A to determine a risk using a machine learning model (e.g., ML models 114) to allowing an entity to access a service using UI screen 282A. Based on the risk score, verification manager 110 may allow access to the service by completing the signup process to create an account for accessing a service as shown at UI screen 283. Alternatively, based on the risk score, the silent verification system 100 may perform a second intervention, as shown in UI screen 284 and temporarily restrict an entity from accessing the service. In some embodiments of the present disclosure, no explicit indication of error or success is shown to the entity. In some examples, silent verification system 100 may perform additional interventions by recommending additional fields and paths to the service to render as UI screens as part of the UI flow illustrated in FIG. 2D. A loop of interventions is described in FIG. 3A description below. For example, an intervention for the last four digits of the SSN may be followed by a request for the entity license ID number, a selfie, a credit card authorization for a small amount, proof of current address, email ID, phone number, ownership of the email ID or phone number using a one-time password (OTP) code, etc. The service may present the interventions as additional fields within UI screen 282 or render them as additional UI screens 272 (as shown in FIG. 2C).

FIG. 2E depicts a UI flow diagram of the silent verification system to help utilize the previously stored information to verify an entity according to one or more embodiments. In particular, the UI flow diagram depicts a signup process to access a service with an intervention for a second input to skip the stages of providing input for all fields. As illustrated in FIG. 2C, UI screen 271 is part of a traditional path to sign up to access a service (e.g., service 130 of FIG. 1). When an entity interacts with UI screen 271 of a service by inputting an email ID using a keyboard resulting in UI screen 272, then UI screen 272 transmits the entity interaction (e.g., entity interaction 271 of FIG. 2A) to verification manager 110 (as shown in FIG. 1; not illustrated in FIG. 2C) to verify the email.

Verification manager 110 transmits a second input request (e.g., second input request 247 of FIG. 2A) presented as second input 275 text field in UI screen 273. UI screen 273 is an intervention modifying the interaction path for signing up for a service by retrieving previously stored information. UI screens 273 and 274 are modified path to sign up for a service that skips stages of filling various fields (as shown in UI screen 271) to access the service.

Second input 275 of UI screen 273 may be a field to retrieve an alternate form of identification of the entity based on information about the identity of the entity stored in a data server, such as data sources 116, that is linked to the email address entered in UI screen 272. In some examples, the filed for second input 275 is itself an alternate form of identification of the entity stored in a data server.

Entity can interact with UI screen 273 rendered as part of an intervention and reject providing access to the alternative form of identification. For example, an entity interacts with UI screen 273 to click “No thanks” button and reject to providing access to alternate form of identification and instead provide original form of identification presented in UI screen 271.

FIGS. 3A-B depicts a handshake sequence diagram for silent verification for service access flow step determination. As illustrated in the FIG. 3A, the handshake for silent verification of entity 310 access to service 370. The handshake between entity 310 and service 130 is managed by verification manager 110. Entity 310 is a user of client 120 (As shown in FIG. 1) interacting through client 120 to access service 130 a merchant offers. In some examples, entity 310 is an account to access service 130.

As illustrated in FIG. 3A, the handshakes between various components of silent verification system 100 results in transactions 301, 302, and 303. A transaction is a set of communications between various components of silent verification system 100 that occur together. Transaction 301 includes a setup for service 130 to let components of verification manager 110 handle the verification of interactions by entity 310. Transaction 302 includes communication between components of silent verification system 100 to verify an interaction from entity 310 to evaluate if the interaction is risky or can be trusted and provide recommendations accordingly. Transaction 303 includes communications between components of silent verification system 100 to finalize a series of interactions that are part of transaction 302. In some examples, transactions may be combined into one transaction or split into smaller transactions. In some examples, there may be dependencies between transactions, for example, transaction 303 occurs only after transaction 302. In some examples, transactions may repeat multiple times, for example, transaction 302 to silently verify an interaction is performed in a loop for a series of interactions to access service 130. It should be noted the numbering of the communication between the components of silent verification system 100 does not determine the order of the information transmitted between the components.

In transaction 301, components of silent verification system 100 interact to set up the user interface for entity 310 to access service 130. The setup aids the components of verification manager 110 to handle verification of interactions by entity 310 to access service 130. Components of verification manager 110, such as assessment service 112, ML models 114, and data source 116, are used to silently verify the interaction (e.g., entity interaction 211 of FIG. 2A) without the involvement or knowledge of entity 310 to connect with verification manager 110. Additional components connected to verification manager 110 and service 130 aid in transforming the interaction from entity 310 for silent verification and output recommendation from a verification result. The transformation may include adding environment information and human-readable or computer readable input to verify the interactions of entity 310 to access service 130.

In step 341, assessment service 112 of verification manager 110 begins transaction 301 by registering a session for receiving interactions from entity 310. Assessment service 112 transmits a session identifier to service 130 for registration. Session identifier helps identify the application and entity 310 interactions in a session to access service 130. Service 130 shares the session identifier with client application 320 to include it as part of entity 310's interactions to access service 130. Client application 320 may be software running on the client device (e.g., client 120 of FIG. 1) entity 310 uses. For example, client application 320 may be a browser to access service 130. In some examples, client application 320 is a user interface for accessing service 370. An interaction by entity 310 may be a keyboard input, a mouse clicks, or a combination of actions performed on client application 320.

In step 371, service 130 communicates with client application 320 to render a UI to access service 130. Service 130 may include the session identifier from step 341 in the UI render request for client application 320. Client application 320 is an application on client 120 (as shown in FIG. 1) to present a UI (e.g., UI screen 261 of FIG. 2B, UI screen 271 of FIG. 2C) for entity 310 to access service 130. Service 130 may list the identifiers of UI component 330 to include in the rendered UI (e.g., UI screen 273 of FIG. 2C) and the layout of UI component 330 for entity 310 to interact as part of accessing service 130.

In step 331, UI component 330 registers with client 120. UI component 330 registration request may include a URL to connect to verification manager 110. In some examples, the registration request may include information about the API to call as part of verifying the interaction. The registration request may include other details such as a token to authenticate access to verification manager 110. UI component 330 is a scripted module that renders a UI widget used by entity 310 to interact with client application 320 to access service 130. Client application 320 executes the code of UI component 330 to render a UI widget (.

In some examples, the registration request includes transmitting the software code required to present a user interface on client application 320. UI component registration request may be sent after a request from client application 320. Client application 320 may transmit a request to UI component 330 based on a render UI request at step 341. A render UI request may include an identifier for the UI component used by client application 320 to request UI component registration. Silent verification system 100 upon completing step 331 of transaction 301, will wait for transaction 302 to verify entity 310's interactions.

Client application 320 presents a UI for accessing service 130. Client application 320 may use UI component 330 as part of the UI for entity 310 to interact. UI components 330 transmit registration request in step 331 of transaction 301 to use as part of the UI presented by client application 320. In step 331, UI component 330 transmits UI component 330's registration request to client application 320 for client application 320 presenting the UI for entity 310 to interact.

In transaction 302, components of silent verification system 100 interact, resulting in silent verification and handling of entity 310's interaction with client application 320 to access service 130. Verifying entity 310's interactions includes providing recommendations for the following stages (e.g., UI screens 262-263 of FIG. 2B, UI screens 273-274 of FIG. 2C) of the interaction path to present to entity 310 to access service 130. Transaction 302 includes multiple steps to transmit entity 310's interaction to verification manager 110 and receive recommendations for interventions to entity 301's attempt to access service 130 presented with an updated UI. In step 311, an interaction (e.g., interaction 211 of FIG. 2A) by entity 310 is transmitted to client application 320.

In step 321, the transmitted interaction is received by client application 320 and is pre-processed before forwarding the interaction to verification manager 110. Client application 320 processes the received transaction to transmit events at step 321 to assessment service 112 of verification manager 110. An event may include the result of entity 310's interaction with client application 320. For example, an event is submitting a form for a submit button click interaction by entity 310. In some examples, a transmitted event includes input provided by entity 310 as part of transmitted interaction in step 311. For example, the input could be the values of fields of a form transmitted with a submission button click interaction.

Client application 320 may transform interaction from step 311 to transmit events in step 321. Transformation may include adding information that provides context for the event. The context includes personal identifiable information (PII) of entity 310 interacting with client application 320. Client application 320 may access PII information using the computing device (e.g., computing device 101) executing client application 320. For example, PII includes the IP address, the MAC address, and the GPS location of the computing device running client application 320. The PII information may also include information about client application 320. For example, a UA string of a browser acting as client application 320 or presenting UI of client application 320. In step 323, client application 320 transmits PII to assessment service 112 to use along with events to verify whether entity 310 can access service 130. Client application 320 may transmit the PII information as separate communication in step 323.

Assessment service 112, upon receiving the event and the associated PII in steps 321 and 323, evaluates to determine recommendations for the next stages in the path to accessing service 130. Assessment service 112 works with ML models 114 and data source 116 to verify entity 310 based on an interaction transmitted in step 311. A detailed description of using assessment service 112, ML models 114, and data source 116 to verify an interaction is presented in the FIG. 2A description above.

In step 341, assessment service 112 transmits a score evaluation request to ML models 114 to use in verifying entity 310. ML models 114 calculates a risk score (e.g., risk score 253 of FIG. 2A) of entity 310's interaction (at step 311) by connecting with data source 116 to retrieve relevant data (e.g., data 251 of FIG. 2A) in step 361.

In step 351, ML models 114 transmit the risk score to assessment service 112 upon evaluating a risk score. Assessment service 112 reviews the risk score to determine a potential intervention stage in entity 310's path to access service 130. Assessment service 112 may determine the intervention stage of a path to access service 13 based on a static mapping between scores and types of services. In some examples, assessment service 112 uses additional rule-based logic to determine the invention based on the score, service type, and other contextual information provided as part of PII.

In step 343, assessment service 112 transmits the intervention to client application 320 to update the path to access service 130. Client application 320 reviews the intervention to determine whether to use the intervention, modify the intervention, or reject the intervention. Client application 320 then transmits a render intervention request in step 333 to UI component 330. Transaction 302 may occur in a loop for various interactions performed by entity 310 based on path and interventions. Upon completing all the interactions and interventions presented in a UI by client application 320, transaction 303 is performed on silent verification system 100 for service 130 to confirm completion.

In transaction 303, entity 310 completes the interaction to access service 130 by completing the last stage in the path to access service 130. In step 315, entity 310 transmits the interaction completion request to client application 320. The last stage may be a last screen of form fields to fill or a click of a submit button provided along with a form. In some examples, interventions may include intermediary completion forms to allow entity 310 to access service 130. Interaction completion may include the completion of form fields presented as part of an intervention and client application 320 submitting a confirmation of acceptance of intervention to service 130. In some examples, the confirmation may include rejecting an intervention proposed by service 130 using client application 320. For example, an intervention to confirm a previously stored profile of entity 310 to help skip stages to access service is rejected by entity 310 by pressing the “Decline” button in UI screen 262 (As shown in FIG. 2B) or “No Thanks” button in UI screen 273 (as shown in FIG. 2C). Service 130, upon receipt of confirmation provides access to a feature to entity 310. In some examples, rejecting an intervention, can result in excluding an entity from accessing a service. The exclusion of access to a service may be another intervention that modifies the path of access to a service by excluding an entity. The exclusion of an entity from accessing a service may be presented by modifying the user interface, for example, disabling fields of the user interface to access the service.

In some examples, service 130 may request an update of entity 310's risk score based on the received confirmation. Service 130, upon receiving submission confirmation may allow entity 310 to access service 130. In some examples, risk score associated with entity 310 accessing service 130 is updated based on entity 310's response interaction to a recommended intervention from verification manager 110 which is part submission confirmation.

As illustrated in FIG. 3B, transaction 305 helps evaluate a group of transactions involving interactions and interventions, such as transaction 302. Evaluation of a transaction may include evaluation of the risk score of entity 310 submitting completion of a transaction through an interaction. Transaction 305 occurs post-completion of interaction by entity 310 to access service 130. In some examples, steps in transaction 305 occur as part of transaction 303 (as shown in FIG. 3A) upon entity 310 confirming the completion of interaction to access service 130. In some examples, transaction 305 is initiated at the end of a transaction that begins as part of transaction 301. For example, transaction 305 is performed after entity 310 is signed out of accessing service 130 or closes client application 320 used to access service 130.

Service 130 begins transaction 305 by requesting to evaluate service 130's decision to accept, reject, or amend interventions recommended by assessment service 112 as part of verifying entity 310. The evaluation request may also include the evaluation of entity 310's interaction following the rendering of intervention UI in step 333. In step 375, the session score request is received by assessment service 112. The session score request includes the decision for intervention recommendation made by verification manager 110 in transaction 302. In some examples, the session score request includes entity 310's interaction with the presented UI intervention. Assessment service 112 uses ML models 114 and data source 116 to determine a session score. In step 345, assessment service 112 transmits a session score evaluation request to ML models 114, similar to a risk score evaluation request for an interaction in step 341 (as shown in FIG. 3A) of transaction 302 (as shown in FIG. 3A). Upon receipt of session score evaluation request, ML models 114 read data in steps 365 from data sources 116. The read data includes similar sessions previously completed by entities similar to entity 310 on services similar to service 130. Finally, in step 355, ML model 114 evaluates the score using read data and session details. Assessment service 112 determines a recommendation based on the session score. Assessment service 112 determines the recommendation based on the interactions performed by entity 310 to access service 130, including input provided, contextual information, and interactions for interventions presented to entity 310.

In step 347, assessment service 112 transmits the recommendations for new interventions based on the session score request, including service 130's decision on intervention recommendations for interactions and entity 310's interaction response to intervention. Unlike the risk score of an interaction, the session score is shared with service 130 along with recommendations including interventions for entity 310 to access service 130. Upon receipt of session recommendations and score, service 130 determines interventions based on recommendation and session score transmitted in step 347.

In step 377, service 130 determines interventions based on the score and recommendations and transmits them to entity 310 through a UI presented on client application 320. Interventions in step 377 may be selected from a list of recommendations shared by assessment service 112. Service 130 transmits the selected interventions from assessment service 112 recommendations or determined interventions based on assessment service 112 recommendations. Entity 310 receives the interventions through a UI rendered on client application 320, similar to interaction interventions rendered in step 333 (as shown in FIG. 3A) of transaction 302. In some examples, service 130 requests assessment service 112 to transmit intervention as part of step 377.

Entity 310 handles intervention received as part of step 377 by interacting with UI components (e.g., UI component 330) representing intervention. An intervention may include additional fields of information requested from entity 310. The additional fields may be alternate ways to verify the information provided as part of the interaction transmitted in step 311 (as shown in FIG. 3A) and interaction completion transmitted in step 315 (as shown in FIG. 3A) transaction 303 (as shown in FIG. 3A). In some examples, the intervention may be a rejection of access to service 130 or revocation of access granted as part of transaction 303. In some examples, assessment service 112 transmits intervention to client application 320 to render updated UI and simultaneously to service 130 for record keeping purposes.

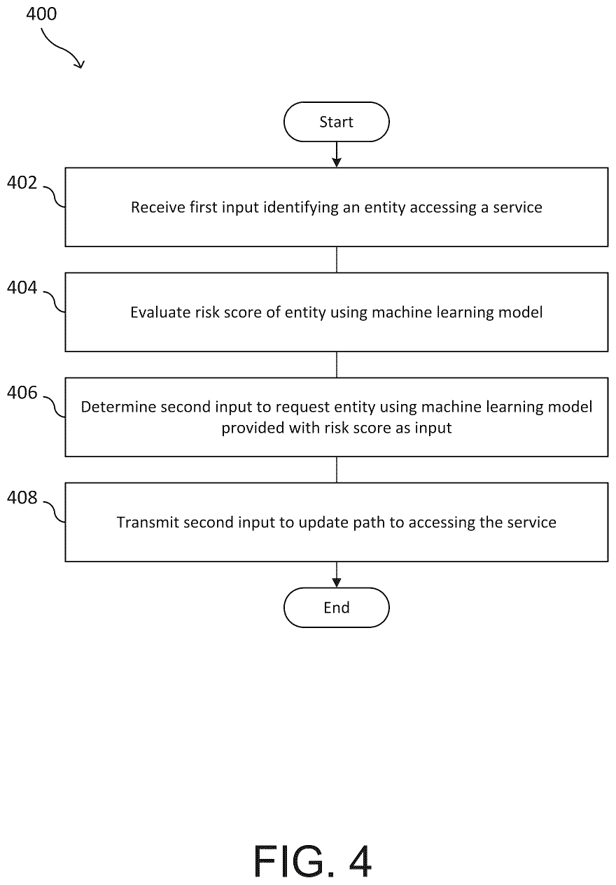

FIG. 4 depicts a flow diagram of a process for silently verifying an entity at each step in a flow to access a service according to one or more embodiments. In step 402, the first input (e.g., first input 241 of FIG. 2A) is received by a verification manager (e.g., verification manager 110 of FIG. 1) for silently verifying the entity's interaction (e.g., entity interaction 211 of FIG. 2A) to access a service (e.g., service 130 of FIG. 1). The first input identifies an entity (e.g., entity 310 of FIG. 3) accessing a service. The first input may include interaction performed by an entity on a UI displayed by a client application (e.g., client application 320 of FIG. 3). The interaction includes the action performed on the UI, keyboard and mouse clicks to provide input to form fields. The first input also includes information about the environment for the interaction, such as information about the entity, the client application, and the client running the client application and used by the entity to access the service.

In step 404, a risk score (e.g., risk score 253 of FIG. 2A) is evaluated based on the first input using an ML model (e.g., ML models 114 of FIG. 1). The ML model may be pre-trained using data source (e.g., data source 116 of FIG. 1). A data source (e.g., data source 116 of FIG. 1) may also be used to retrieve an input prompt data to be provided along with first input to determine risk score. The input prompt data includes data associated with the first input received in step 402. The ML models may be used to determine the most relevant data from a data source to use as an input prompt for determining the risk score.

ML models 114 may retrieve previous risk score associated with an entity based on past interaction with service 130 and other services. ML models 114 may use the retrieved previous risk score as input and update it based on the current interaction (e.g., entity interaction 211 of FIG. 2A) received from a client application of client 120.

In step 406, a request for a second input (e.g., second input request 247 of FIG. 2A) is generated based on the evaluated risk score in step 404. The second input is a recommendation to a service to intervene in an entity's access to a service. The intervention may be a request to the entity for additional input to verify the entity presented as form fields in a client application. The intervention can include a rejection or denial of access to service 130. In some examples, a second input request may help skip certain stages of a path to access service. The risk score evaluated in step 404 is provided as input to the ML models to generate the second input request to an entity.

In step 408, the second input request determined in step 406 is transmitted to update the path to accessing the service. The second input is received by a client application to render a UI screen with the second input presented as UI fields. The rendered UI screen acts as an additional intermediary screen placed in the path of UI for an entity to access a feature of a service. For example, the intermediary screen may be a request to upload documents verifying the entity interacting with a client application to access a service. In some examples, the rendered UI creates a new path to access a service. The new path may result in the entity receiving access to a modified service feature. For example, a service may offer a path to accessing a limited-time trial of a pro feature instead of full access to mitigate the potential risk of breach of terms of service.

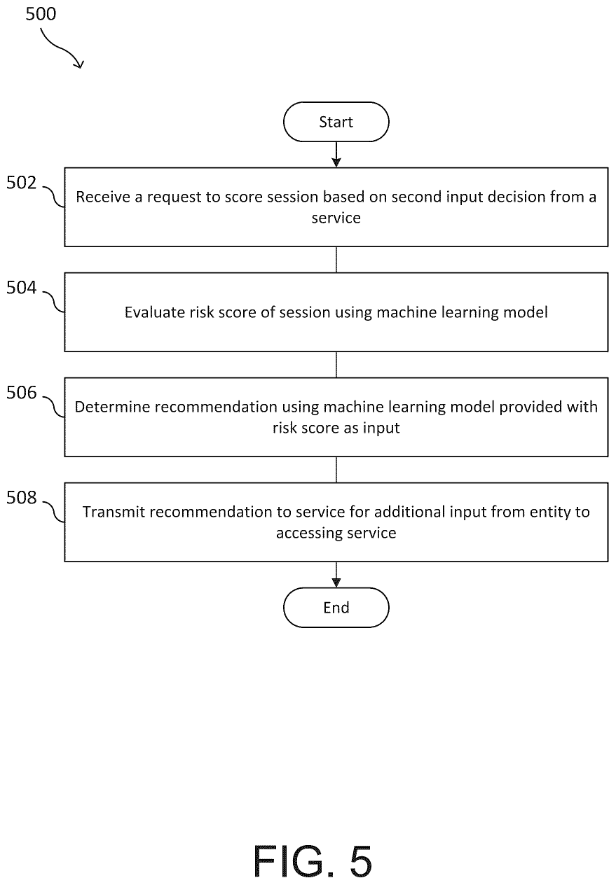

FIG. 5 depicts a flow diagram of a process for determining the next step in a flow to access a service according to one or more embodiments. In step 502, a request to score a session is received from a service (e.g., service 130 of FIG. 1). The request to score a session includes a service's decisions for various second input requests (e.g., second input request 247 of FIG. 2A) recommendations as generated in method 400 above. In some examples, a request to score a session also includes interaction responses provided by an entity for second input requests presented to an entity. A session may include a group of interactions an entity (e.g., entity 310 of FIG. 3) performed to access a service. For example, transaction 302 (as shown in FIG. 3A) represents a loop of interactions by entity 310 (as shown in FIG. 3A) forming a session and the session is scored in transaction 305 (as shown in FIG. 3B).

In step 504, the risk score of a session is determined by an ML model (e.g., ML models 114 of FIG. 1). The ML model may retrieve data from a data source (e.g., data source 116 of FIG. 1) to use as input prompt along with session score request information from step 502 to determine a risk score of a session.

In step 506, a recommendation for a session based on the session information received in step 502 is determined using an ML model. The recommendation may be an additional input request for an entity to provide access to a service. The additional input may also include a rejection of previously approved access to a service or a revocation or limits to accessing a service based on additional input requested from an entity.

In step 508, the recommendation is transmitted to a service along with the risk score of the session. The service reviews the received recommendations and the session score to determine an intervention for an entity in its interaction path to accessing the service. The intervention may be one of the recommendations determined in step 506 above. In some examples, the intervention may be a modification of a recommendation or a combination of multiple recommendations determined in step 506 above. The service transmits the determined intervention to the entity by rendering an updated UI screen for an entity to interact with to access a service.

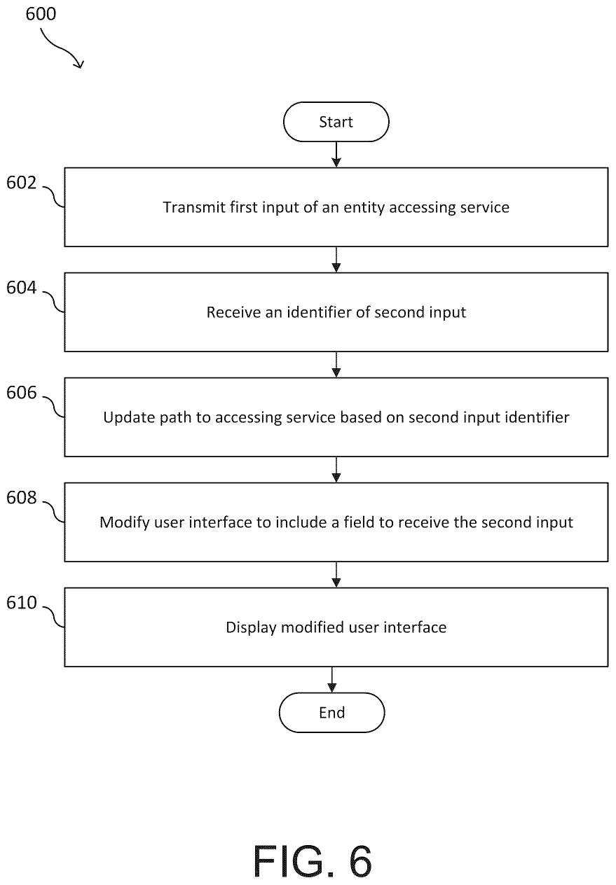

FIG. 6 depicts a flow diagram of a process for dynamic selection of the next step in a flow to access a service according to one or more embodiments. In step 602, the first input (e.g., first input 241 of FIG. 2A) from an entity (e.g., entity 310 of FIG. 3) accessing a service (e.g., service 130 of FIG. 1) is transmitted for silent verification. The first input is transmitted without an entity request to silently verify the first input to evaluate the risk of allowing the entity to access the service. Silent verification system 100 may employ specialized UI components interacted by an entity to dynamically transmit the entity's interactions silently for verification to a verification manager (e.g., verification manager 110 of FIG. 1).

In step 604, an identifier to a second input (e.g., second input request 247 of FIG. 2A) is received. The second input may include a request for additional information from an entity. The identifier to a second input may be used to access a UI component (e.g., UI component 330 of FIG. 3).

In step 606, the path to access a service is updated based on the second input identifier. The path to access includes a series of UI screens to present to an entity interacting to access a service. For example, the path may be a signup wizard to access pro features of a service, and the path can be modified by adding a UI screen or skipping a UI screen. The path update is based on the risk level associated with an entity accessing a service. The risk level is assessed from the second input identifier. For example, a second input identifier to an email verification link field indicates that the entity has a stored profile and is trustworthy. In another example, a second input identifier to an import file field for verifying the authenticity of an entity indicates that the entity is not trustworthy.

In step 608, the user interface presented to an entity to interact is modified based on the second input identifier. The second input identifier is used to retrieve UI components that can receive a second input as part of an entity interaction. The UI component is rendered on the existing user interface interacted by a client. The modification of UI is based on the updated path as determined in step 606 above. The UI screen may be modified inline to include additional UI components retrieved using a second input identifier or included as a new UI screen.

In step 610, the modified user interface from step 608 is displayed. A client application (e.g., client application 320 of FIG. 3A) may display the modified user interface.

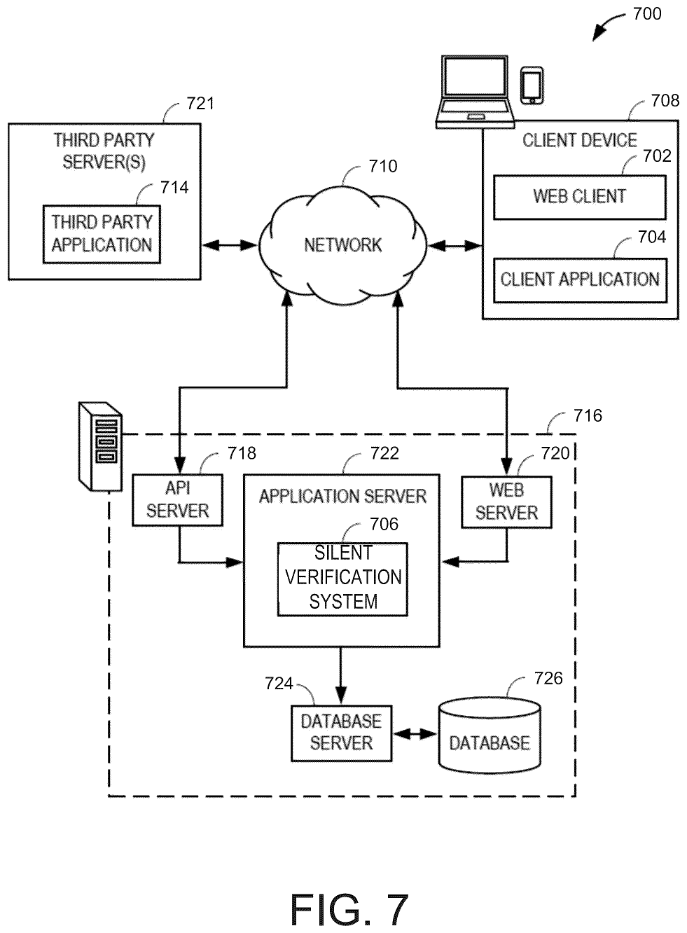

With reference to FIG. 7, an example embodiment of a high-level SaaS network architecture 700 is shown. Networked system 716 provides server-side functionality via a network 710 (e.g., the Internet or a WAN) to client device 708. Web client 702 and a programmatic client, in the example form of client application 704 (e.g., a client application for client 120 of silent verification system 100 of FIG. 1), are hosted and executed on client device 708. Networked system 716 includes one or more servers 722 (e.g., servers hosting services exposing remote procedure call APIs), which hosts silent verification system 706 (such as silent verification system 100 of FIG. 1 described above according to various embodiments of the present disclosure supporting service for automatically processing accounting data) that provides a number of functions and services via a service oriented architecture (SOA) and that exposes services to client application 704 that accesses networked system 716 where the services may correspond to particular workflows. Client application 704 also provides a number of interfaces described herein, which can present an output in accordance with the methods described herein to a user (e.g., entity 310 of FIG. 3) of client device 708.

Client device 708 enables a user to access and interact with networked system 716 and, ultimately, silent verification system 706. For instance, the user provides input (e.g., touch screen input or alphanumeric input) to client device 708, and the input is communicated to networked system 716 via network 710 (such as data communication network 140 of FIG. 1). In this instance, networked system 716, in response to receiving the input from the user, communicates information back to client device 708 via network 710 to be presented to the user.

API server 718 and web server 720 are coupled, and provide programmatic and web interfaces respectively, to servers 722. For example, API server 718 and web server 720 may produce messages (e.g., RPC calls) in response to inputs received via network 710, where the messages are supplied as input messages to workflows orchestrated by silent verification system 706. API server 718 and web server 720 may also receive return values (return messages) from silent verification system 706 and return results to calling parties (e.g., web clients 702 and client applications 704 running on client device 708 and third-party applications 714) via network 710. Servers 722 host silent verification system 706, which includes components or applications in accordance with embodiments of the present disclosure as described above. Servers 722 are, in turn, shown to be coupled to one or more database servers 724 that facilitate access to information storage repositories (e.g., databases 726). In an example embodiment, databases 726 includes storage devices that store information accessed and generated by the silent verification system 706, such as data sources of FIG. 1 and other databases such as databases storing information associated with transactions processed by a merchant.

Additionally, third-party application 714, executing on one or more third-party servers 721, is shown as having programmatic access to networked system 716 via the programmatic interface provided by API server 718. For example, the third-party application 714, using information retrieved from the networked system 716, may support one or more features or functions on a website hosted by a third-party. For example, the third-party application 714 may serve as a data source for retrieving, for example, data source 116 of silent verification system 100.

Turning now specifically to the applications hosted by client device 708, web client 702 may access the various systems (e.g., silent verification system 706) via the web interface supported by web server 720. Similarly, client application 704 (e.g., an “app” such as a browser with a rendered website to access service 130 of FIG. 1) may access the various services and functions provided by silent verification system 706 via the programmatic interface provided by API server 718. Client application 704 may be, for example, an “app” executing on client device 708, such as an iOS or Android OS application to enable a user to access and input data on networked system 716 in an offline manner and to perform batch-mode communications between client application 704 and networked system 716.

Further, while network architecture 700 shown in FIG. 7 employs a client-server architecture, the present disclosure is not limited to such an architecture, and could equally well find application in a distributed, or peer-to-peer, architecture system, for example.

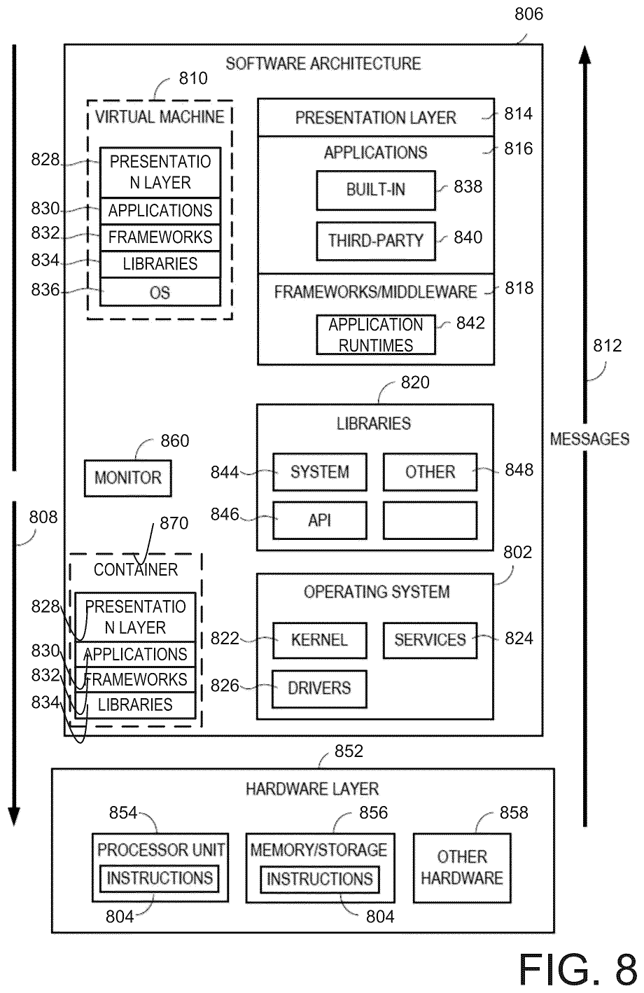

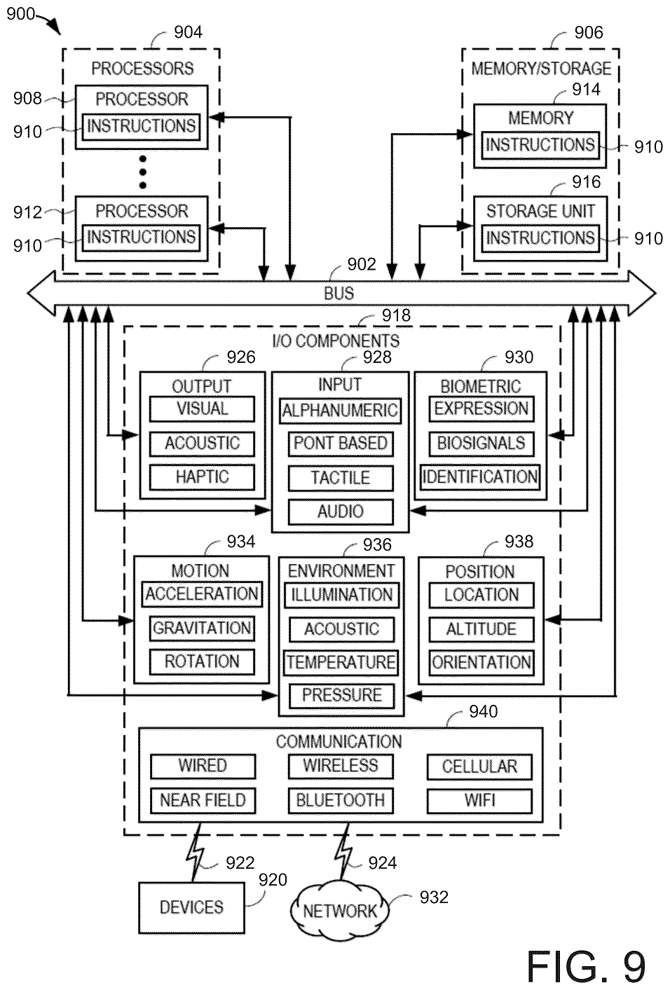

FIG. 8 is a block diagram illustrating an example software architecture 806, which may be used in conjunction with various hardware architectures herein described. FIG. 8 is a non-limiting example of software architecture 806, and it will be appreciated that many other architectures may be implemented to facilitate the functionality described herein. Software architecture 806 may execute on hardware such as machine 900 of FIG. 9 that includes, among other things, processors 904, memory/storage 906, and input/output (I/O) components 918. A representative hardware layer 852 is illustrated and can represent, for example, machine 900 of FIG. 9. The representative hardware layer 852 includes processor 854 having associated executable instructions 804. The executable instructions 804 represent the executable instructions of software architecture 806, including implementation of the methods, components, and so forth described herein. Hardware layer 852 also includes non-transitory memory and/or storage modules as memory/storage 856, which also have the executable instructions 804. Hardware layer 852 may also include other hardware 858.

In the example architecture of FIG. 8, software architecture 806 may be conceptualized as a stack of layers where each layer provides particular functionality. For example, software architecture 806 may include layers such as operating system 802, libraries 820, frameworks/middleware 818, applications 816 (such as service 130 of silent verification system 100 of FIG. 1), and a presentation layer 814. Operationally, applications 816 and/or other components within the layers may invoke API calls 808 through the software stack and receive a response as messages 812 in response to API calls 808. The layers illustrated are representative in nature, and not all software architectures have all layers. For example, some mobile or special-purpose operating systems may not provide frameworks/middleware 818, while others may provide such a layer. Other software architectures may include additional or different layers.

Operating system 802 may manage hardware resources and provide common services. Operating system 802 may include, for example, kernel 822, services 824, and drivers 826. Kernel 822 may act as an abstraction layer between the hardware and the other software layers. For example, kernel 822 may be responsible for memory management, processor management (e.g., scheduling), component management, networking, security settings, and so on. Services 824 may provide other common services for the other software layers. Drivers 826 are responsible for controlling or interfacing with the underlying hardware. For instance, drivers 826 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

Libraries 820 provide a common infrastructure that is used by applications 816 and/or other components and/or layers. Libraries 820 provide functionality that allows other software components to perform tasks in an easier fashion than by interfacing directly with the underlying operating system 802 functionality (e.g., kernel 822, services 824, and/or drivers 826). Libraries 820 may include system libraries 844 (e.g., C standard library) that may provide functions such as memory allocation functions, string manipulation functions, mathematical functions, and the like. In addition, libraries 820 may include API libraries 846 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. Libraries 820 may also include a wide variety of other libraries 848 to provide many other APIs to applications 816 and other software components/modules.

Frameworks/middleware 818 provide a higher-level common infrastructure that may be used by applications 816 and/or other software components/modules. For example, frameworks/middleware 818 may provide high-level resource management functions, web application frameworks, application runtimes 842 (e.g., a Java virtual machine or JVM), and so forth. Frameworks/middleware 818 may provide a broad spectrum of other APIs that may be utilized by applications 816 and/or other software components/modules, some of which may be specific to a particular operating system or platform.

Applications 816 include built-in applications 838 and/or third-party applications 840. Applications 816 may use built-in operating system functions (e.g., kernel 822, services 824, and/or drivers 826), libraries 820, and frameworks/middleware 818 to create UIs to interact with users of the system. Alternatively, or additionally, in some systems, interactions with a user may occur through a presentation layer, such as presentation layer 814. In these systems, the application/component “logic” can be separated from the aspects of the application/component that interact with a user.

Some software architectures use virtual machines. In the example of FIG. 8, this is illustrated by virtual machine 810. Virtual machine 810 creates a software environment where applications/components can execute as if they were executing on a hardware machine (such as machine 900 of FIG. 9, for example). Virtual machine 810 is hosted by a host operating system (e.g., operating system 802 in FIG. 8) and typically, although not always, has virtual machine monitor 860 (or hypervisor), which manages the operation of virtual machine 810 as well as the interface with the host operating system (e.g., operating system 802). A software architecture executes within virtual machine 810 such as operating system (OS) 836, libraries 834, frameworks 832, applications 830, and/or presentation layer 828. These layers of software architecture executing the virtual machine 810 can be the same as corresponding layers previously described or may be different.

Some software architectures use containers 870 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 870 is similar to a virtual machine in that it includes a software architecture including libraries 834, frameworks 632, applications 830, and/or presentation layer 828, but omits an operating system and, instead, communicates with the underlying host operating system 802.

FIG. 9 is a block diagram illustrating components of machine 900, according to some example embodiments, able to read instructions from a non-transitory machine-readable medium (e.g., a computer-readable storage medium) and perform any one or more of the methodologies discussed herein. Specifically, FIG. 9 shows a diagrammatic representation of machine 900 in the example form of a computer system, within which instructions 910 (e.g., software, a program, an application, an applet, an app, or other executable code) for causing machine 900 to perform any one or more of the methodologies discussed herein may be executed. As such, instructions 910 may be used to implement modules or components described herein. Instructions 910 transform the general, non-programmed machine 900 into a particular machine 900 programmed to carry out the described and illustrated functions in the manner described. In alternative embodiments, machine 900 operates as a standalone device or may be coupled (e.g., networked) to other machines. In a networked deployment, machine 900 may operate in the capacity of a server machine or a client machine in a server-client network environment, or as a peer machine in a peer-to-peer (or distributed) network environment. Machine 900 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing instructions 910, sequentially or in parallel or concurrently, that specify actions to be taken by machine 900. Further, while only a single machine 900 is illustrated, the term “machine” or “processing circuit” shall also be taken to include a collection of machines that individually or jointly execute the instructions 910 to perform any one or more of the methodologies discussed herein.

Machine 900 may include processors 904 (including processors 908 and 912), memory/storage 906, and I/O components 918, which may be configured to communicate with each other such as via bus 902. Memory/storage 906 may include memory 914, such as a main memory, or other memory storage, and storage unit 916, both accessible to processors 904 such as via bus 902. Storage unit 916 and memory 914 store instructions 910 embodying any one or more of the methodologies or functions described herein. Instructions 910 may also reside, completely or partially, within memory 914, within storage unit 916, within at least one of processors 904 (e.g., within the processor's cache memory), or any suitable combination thereof, during execution thereof by machine 900. Accordingly, memory 914, storage unit 916, and the memory of processors 904 are examples of machine-readable media.

I/O components 918 may include a wide variety of components to receive input, provide output, produce output, transmit information, exchange information, capture measurements, and so on. The specific I/O components 918 that are included in a particular machine will depend on the type of machine. For example, portable machines such as mobile phones may include a touch input device or other such input mechanisms, while a headless server machine will likely not include such a touch input device. It will be appreciated that the I/O components 918 may include many other components that are not shown in FIG. 9. I/O components 918 are grouped according to functionality merely for simplifying the following discussion, and the grouping is in no way limiting. In various example embodiments, I/O components 918 may include output components 926 and input components 928. Output components 926 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. Input components 928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, I/O components 918 may include biometric components 930, motion components 934, environment components 936, or position components 938, among a wide array of other components. For example, biometric components 930 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. Motion components 934 may include acceleration sensor components (e.g., accelerometer), gravitation sensor components, rotation sensor components (e.g., gyroscope), and so forth. Environment components 936 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. Position components 938 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. I/O components 918 may include communication components 940 operable to couple machine 900 to network 932 or devices 920 via coupling 924 and coupling 922, respectively. For example, communication components 940 may include a network interface component or other suitable device to interface with network 932. In further examples, communication components 940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. Devices 920 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF, Ultra Code, UCC RSS-2D bar code, and other optical codes), or acoustic detection components (e.g., microphones to identify tagged audio signals). In addition, a variety of information may be derived via communication components 940, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

In an aspect, the technology relates to silent and smart verification of entities. The server includes at least one processor, and memory coupled to the processor, the memory consisting of computer executable instructions that are executed by the system to perform operations. The operations include: receiving a first input identifying an entity engaged in a flow for accessing a service, evaluating a risk score of the entity using a machine learning model that takes as input: associations of the entity that are based on an access history of the entity for a second service that is stored in the server, and a type of access to the service, determining a second input for the entity to access the service using the machine learning model with the risk score of the entity as an input, and transmitting the second input to the service to update the flow to access the service.

In an example, the entity accessing a service comprises a request to access a feature of the service. In another example, the second input includes one or more steps to access the feature of the service. In still another example, the operations further include excluding the entity from accessing the feature of the service based on the risk score.

In an example, the first input comprises data automatically retrieved from a user interface used to access the service.

In an example, evaluating a risk score of the entity based on the combination of the associations of the entity and type of access to the service that, when executed by the processor, cause the processor to perform further operations. The operations include retrieving a previous risk score associated with the entity and updating the previous risk score to the risk score based on the combination of the associations of the entity and the type of access to the service.

In an example, the second input includes a field for an alphanumeric identifier to confirm the identity of the entity. In another example, the field is an alternate form of identification of the entity based on information about the identity of the entity stored in the server. In still another example, wherein the entity can select to provide an original form of identification of the entity instead of the alternate form of identification of the entity.

In an example, the second input comprises a request for an alternate document identifying the entity.

In an example, the machine learning model takes as input a feature of the service.

In another aspect, the technology related to a computer-implemented method for silent and smart verification of entities. The method includes: transmitting a first input by an entity for a field of a user interface of a flow to access a service, receiving an identifier of a second input, updating the flow to access the service based on the identifier of a second input, modifying the user interface to include a field to receive the second input, and displaying the modified user interface.

In an example, access to a service comprises a request to access a feature of the service. In another example, the second input includes one or more steps to access the feature of the service.

In an example, the identifier of the second input is determined by a machine learning model that takes as input a feature of the service.

In an example, the method further includes excluding the entity from accessing the service based on the second input, wherein the second input modifies the user interface to disable fields of the user interface to access the service.

In an example, the first input comprises data automatically retrieved from the user interface.

In an example, the second input is based on a risk score computed using an access history of the entity to a second service.

In an example, the second input is based on a risk score computed using an access history of the entity to a second service. In another example, the field is an alternate form of identification of the entity based on information stored in a server.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A server comprising:
a processor; and
a memory, wherein the memory stores instructions that, when executed by the processor, cause the processor to:
receive a first input identifying an entity engaged in a flow for accessing a service;
evaluate a risk score of the entity using a machine learning model that takes as input: associations of the entity that are based on an access history of the entity for a second service that is stored in the server, and a type of access to the service; and
determine a second input for the entity to access the service using the machine learning model with the risk score of the entity as an input; and
transmit the second input to the service to update the flow to access the service.

2. The server of claim 1, wherein the entity accessing a service comprises a request to access a feature of the service.

3. The server of claim 2, wherein the second input includes one or more steps to access the feature of the service.

4. The server of claim 2, wherein the instructions further cause the processor to:
exclude the entity from accessing the feature of the service based on the risk score.

5. The server of claim 1, wherein the first input comprises data automatically retrieved from a user interface used to access the service.

6. The server of claim 1, wherein the memory further stores instructions to evaluate a risk score of the entity based on the combination of the associations of the entity and type of access to the service that, when executed by the processor, cause the processor to:
retrieve a previous risk score associated with the entity; and
update the previous risk score to the risk score based on the combination of the associations of the entity and the type of access to the service.

7. The server of claim 1, wherein the second input includes a field for an alphanumeric identifier, to confirm identity of the entity.

8. The server of claim 7, wherein the field is an alternate form of identification of the entity based on information about the identity of the entity stored in the server.

9. The server of claim 8, wherein the entity can select to provide an original form of identification of the entity instead of the alternate form of identification of the entity.

10. The server of claim 1, wherein the second input comprises a request for an alternate document identifying the entity.

11. The server of claim 1, wherein the machine learning model takes as input a feature of the service.

12. A method comprising:
transmitting a first input by an entity for a field of a user interface of a flow to access a service;
receiving an identifier of a second input;
updating the flow to access the service based on the identifier of a second input;
modifying the user interface to include a field to receive the second input; and
displaying the modified user interface.

13. The method of claim 12, wherein access to a service comprises a request to access a feature of the service.

14. The method of claim 12, wherein the second input includes one or more steps to access a feature of the service.

15. The method of claim 12, wherein the identifier of the second input is determined by a machine learning model that takes as input a feature of the service.

16. The method of claim 12 further comprises:
excluding the entity from accessing the service based on the second input, wherein the second input modifies the user interface to disable fields of the user interface to access the service.

17. The method of claim 12, wherein the first input comprises data automatically retrieved from the user interface.

18. The method of claim 12, wherein the second input is based on a risk score computed using an access history of the entity to a second service.

19. The method of claim 12, wherein the second input includes a field for an alphanumeric identifier, to confirm identity of the entity.

20. The method of claim 19, wherein the field is an alternate form of identification of the entity based on information stored in a server.
